(19) United States
(12) Patent Application Publication
(10) Pub. No.: US 2001/0037463 A1
(43) Pub. Date: Nov. 1, 2001

(54) Method of and system for developing a personal folder via the internet of parties to whom notifications are to be sent of changes in name, address and/or e-mail information

(76) Inventor: Robert J. Salta, Prince Frederick, MD (US)

Correspondence Address: MATTINGLY, STANGER & MALUR, P.C., 1800 DIAGONAL ROAD, SUITE 370, ALEXANDRIA, VA, 22314, US

(21) Appl. No.: 09/801,714

(22) Filed: Mar. 9, 2001

Related U.S. Application Data
(60) Provisional application No. 60/188,000, filed on Mar. 9, 2000.

(51) Int. Cl. H04L 9/00

(52) U.S. Cl. 713/201

(57) ABSTRACT

A method of the Internet in conjunction with the World Wide Web protocol known as Hyper Text Transfer Protocol (HTTP) to provide a reliable and flexible notification delivery service. This service transmits to designated persons or businesses a message specified by the user requesting the notification. The user can enter or select from a database, names, postal addresses, and e-mail addresses of persons or businesses maintained in an online database. This information is then transferred into a secured personal folder stored on a database server. At any given time the user can access their personal folder by entering their user identification and password to direct the system to send notification via e-mail or regular mail for life stage events such as address correction, change of name, etc. After the notification process has been carried out the server system maintains a database of all information completed.

### FIELD OF THE INVENTION

The invention relates to a method and system for developing a personal folder via the Internet of name, address and e-mail information and parties to be notified when sending notifications via e-mail or regular mail of changes in same. In particular, the invention relates to electronic communications via the World Wide Web and a system and method for interactive communication simplifying the process of sending notifications, such as business and residence address changes as well as name and e-mail address changes to a variety of parties through a central web site.

### BACKGROUND OF THE INVENTION

Currently consumers desiring to send notifications for events such as address correction, change of name, change of employment, etc. are confronted with an expensive and time-consuming process. In general, consumers are extremely busy and have less free time than in the past. Individuals waste time and are inconvenienced when required to patronize a store, or government agency to purchase or pick-up notification cards or stationary for effecting such changes. Supplying the appropriate postage may require a special trip to the post office or other facility to purchase stamps. For many consumers, those who are caregivers to loved ones, for example, find it almost impossible to run errands for such needs. Additional time and effort is required to compose, address, seal, and mail such notices. As a further inconvenience, consumers must maintain the names and addresses of persons or businesses to whom they find it necessary to send such notices. For some individuals the ability to look-up the address of a business establishment or individual is a lengthy, time consuming task.

Traditional methods for sending notifications require a person to maintain a personal address book and complete the notifications by hand. Although this task may now be performed using a personal computer, specialized expertise and expensive software is required. As a result, notices are often sent in an untimely manner and in some cases not at all. In the case of address correction notifications, failure to notify businesses in a timely manner may result in late fees charged to the consumer.

It is further difficult for consumers to maintain records of recipients to whom they have sent notifications. This at times will cause consumers wasted time and expense due to the possible duplication of such efforts. Due to the above problems and difficulties, consumers need access to a system providing a convenient and flexible method for sending notifications. This system should enable a method of maintaining a list of family, friends and businesses as well as a record of notified recipients. The present method provides for a convenient and efficient alternative to what is currently available.

### OBJECTS OF THE INVENTION

One object of the present invention is to provide a method and system for developing a personal folder via the Internet of name, address and e-mail information combined with a list of parties, such as personal contacts and businesses, to whom notices should be sent in the event of a change in a person's name, street address and/or e-mail address. The system is required to receive information concerning changes to such information that is input by a consumer or user, preferably through an interactive web site. In response to the input of changes of name, address and e-mail information, notifications are sent through the system via e-mail or regular mail. Thus, a user can input the changes one time via the Internet and have notifications of the change(s) sent to the intended parties from a notification list set up by the user. The service provider can receive the changed information through its web site and provide a reliable and flexible notification service to deliver to designated persons or businesses via e-mail or regular mail the notification with or without an additional message which may be pre-stored on a server system.

It is a further object of the invention to allow any person or business to create a personal folder to be housed on the server system of the provider and to permit the user to select the names and addresses of parties to be notified in the case of a change in information. Preferably, the process of setting up the notification list is aided by access through the web site to a national directory. If the user is unaware of the correct address, for example, a database of directory information can be searched to locate the correct address.

Still further, in the process of inputting information into the personal folder, the user is permitted to modify the information extracted from the server database before adding it to their personal folder. Preferably, in generating the notifications, the user is permitted to add a personal salutation to each of the records in the personal folder. Also, the user can review and approve the notification process before executing a delivery order for either e-mail or regular mail delivery of the notifications. The system provides that users can access their personal folder for the purpose of reviewing information and notification history. Also, users can repeat the notification process each time there is a change in their name, email address or street address by reviewing the names and addresses in the notification list in their personal folder and signaling execution of the notification process via the “deliver” button, thereby simplifying the notification process to a great extent.

### BRIEF DESCRIPTION OF THE DRAWINGS

FIG. 1 is an overview of the user notification process including the user entered information and the system provided menus that achieve the notification process according to a preferred embodiment of the invention.

FIG. 2 is a flow chart of the procedure for establishing a user account according to the invention.

FIG. 3 is a flow chart of the interactive procedure for entering a change in a user's name according to the invention.

FIG. 4 is a flow chart of the interactive procedure for entering a change in a user's e-mail address according to the invention.

FIG. 5A is a flow chart of the interactive procedure for entering a change in a user's street address according to the invention.

FIG. 5B shows a list of address formats that comply with the postal address standardization program for Old and New Addresses to be selected by the user.

FIG. 5C shows the web page returned to the user in which the input fields are specified according to the address format selected in FIG. 5 B.

FIG. 6 is a flow chart of the procedure for selecting parties that are to receive a notification of the change in the user's information to thereby create a notification list for the personal folder according to the invention.

FIG. 7 is a flow chart of the procedure for entering the name, street and/or e-mail address of a personal contact who will receive a notification of the change in information according to the invention.

FIG. 9 is a flow chart of the steps performed in generating a list of user information and a database of e-mail addresses of the users of the system according to the invention.

FIG. 10 is a block diagram of the system including the hardware connected to the Internet according to a preferred embodiment of the invention.

### DETAILED DESCRIPTION OF THE PREFERRED EMBODIMENTS

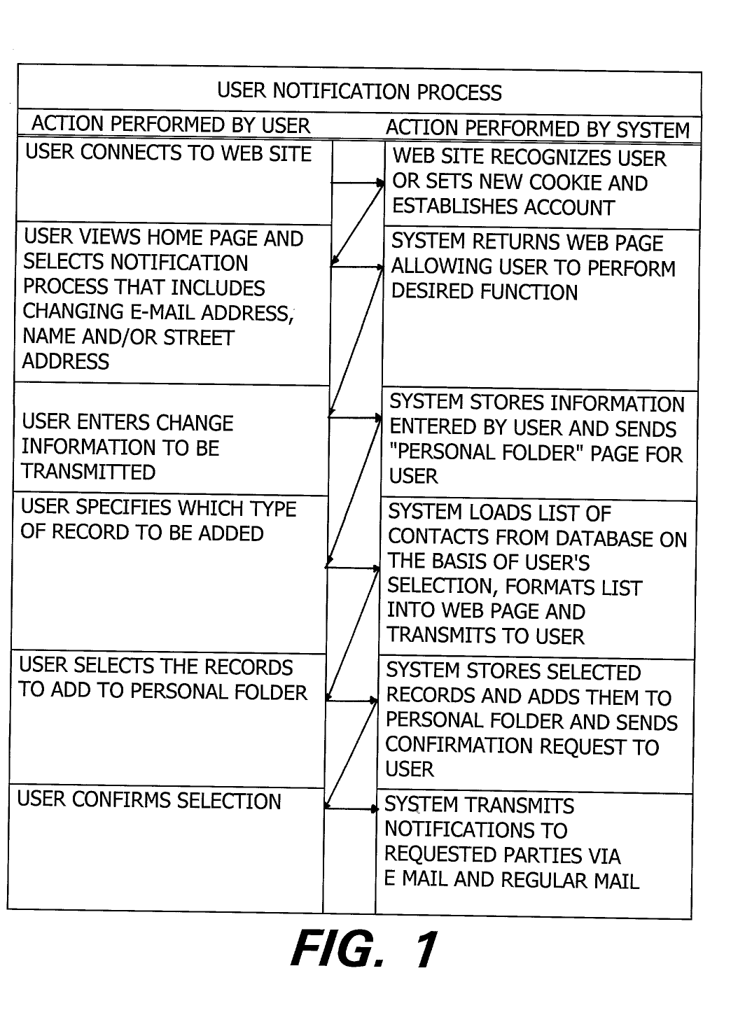

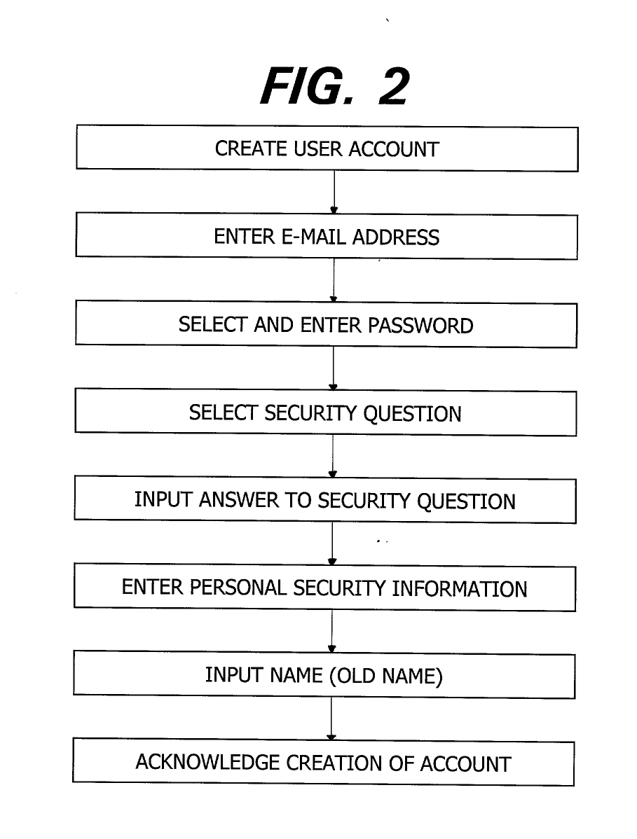

As shown in FIG. 1, first as specified in the column “Action Performed by User,” the user connects to the system via HTTP over the Internet, and is presented with options on a “main menu”. As explained in the column “Action Performed by System”, the system uses the web site access to recognize a cookie on the user's computer or to set a new cookie on the computer. If the user has an account, then the system queries the user to identify themselves to the service with an authentication screen before being allowed to access the functions of the system. Also, a new account can be established for the user. FIG. 2 shows the flow of the procedure for establishing an account if the user does not already have an account.

According to FIG. 2, a user, who has not used the system before and therefore has no username and password, establishes a new account by first entering an e-mail address as a user name and then selecting a password. Additionally, a security question is selected from a menu by the user. Several security questions can be offered for selection by the user, such as “What is your mother's maiden name”. The user inputs an answer to the selected security question and is also prompted for additional security information, such as the user's birthday. At this point, the user enters their old name, for example their maiden name if just married. If no change in the user's name is contemplated, then the user's current name is entered. At this point, as shown in the last step of FIG. 2, the account is created for the user and the user's personal folder is created into which the user's personal information is entered as a first step of creating the personal folder.

Once a user is in the system, as shown in FIG. 1, the web site's server returns a web page and functions of the system can be selected. The options presented to the user on the “main menu” include, but are not limited to:

(1) change registered mailing address;

(2) change registered e-mail address;

(3) send an announcement concerning a change of information resulting from a “life stage” event;

(4) search for a business or an individual who has registered a relocation event or change in an e-mail address or name using U.S. Post Office records and other publicly available directories and provider generated databases; and

(5) access services made available to the user through the system as a result of targeting the user on the basis of the personal information entered into the user's personal folder and in the user's profile information entered as requested through the web site.

After selecting the notification process, and receiving the returned web page from the system allowing the user to perform the desired function, as shown in FIG. 1, the user enters the change information to be transmitted. In response, the system stores the information entered by the user and sends a personal folder page for the user to create the notification list. Upon receiving the personal folder page from the system, the user specifies which type of record to be added. In response, the system loads a list of contacts from a database on the basis of this selection by the user and formats the list into a web page and transmits it to the user's computer. The notification list is created by the user selecting the records to add to the personal folder. In response to the selection of these records, the system stores the selected records and adds them to the personal folder and sends a confirmation request to the user. The user then confirms the selection and in the last action performed by the system, the system transmits the notification to the requested parties in the notification list via e-mail and regular mail.

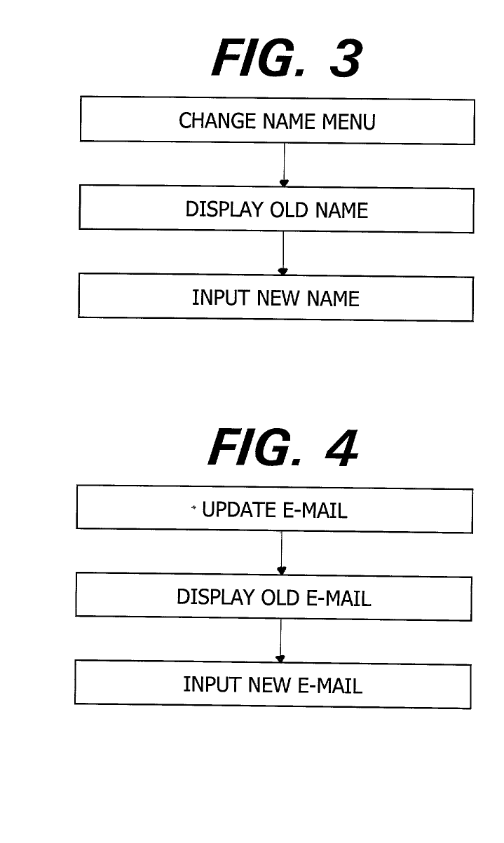

FIG. 3 shows a flow chart of the interactive procedure for entering a change in the user's name according to the invention. Since the user has previously entered their name, they enter the change name menu whereupon the old name is displayed for verification by the user. Following the display of the old name, as shown in FIG. 3, a new name is input thus ending the procedure for changing the user's name.

FIG. 4 shows a procedure for changing a user's e-mail address. First, the user selects the menu for updating the user's e-mail address. In response, the system retrieves the registered e-mail address of the user, which is displayed as an “old e-mail address”. In response, the user inputs the new e-mail and this completes the change in the user's e-mail address.

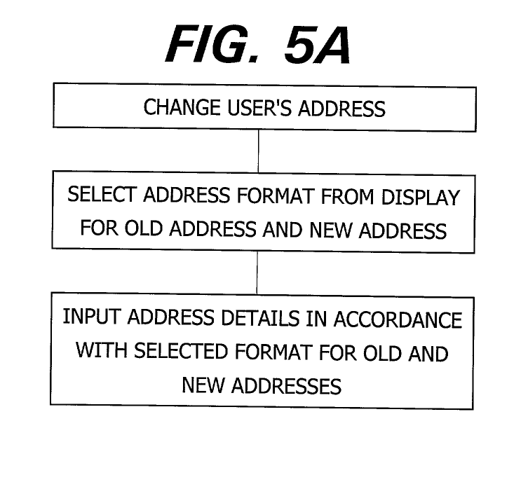

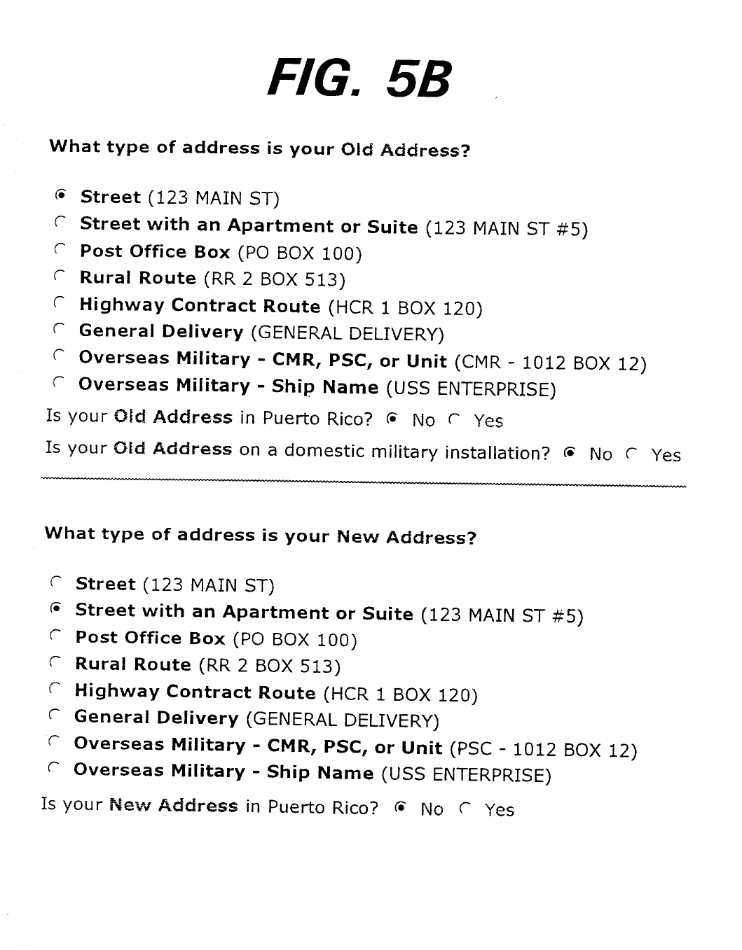

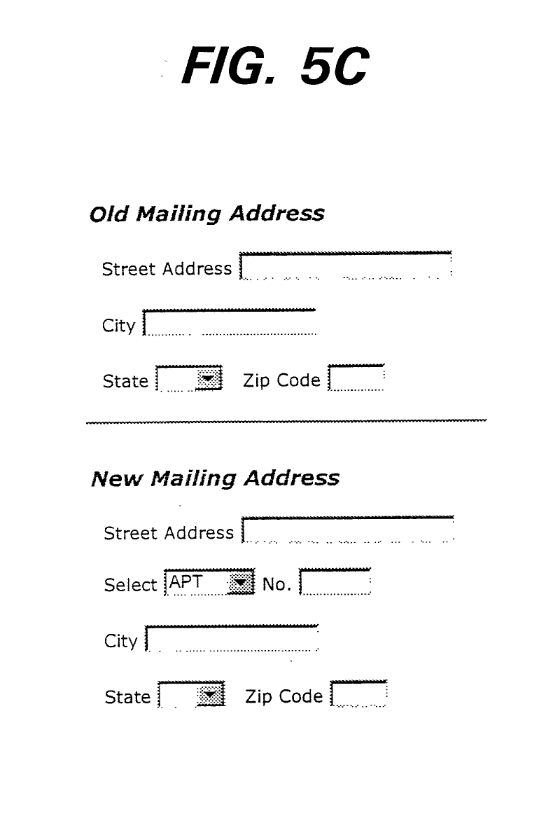

FIG. 5 shows the procedure for changing a user's address. First, the user selects the change user's address menu at the web site. In response, the system transmits a web page having a variety of address formats that conform with the postal address standardization program. The user selects one of the formats from the list for the old address and one of the formats from a separate list for the new address. After the user determines the address format for the old address and the new address, the user returns a web page having input fields displayed in accordance with the selected format for the old address and the new address. The user then enters the details of the address in the fields provided in the web page that has been returned by the system, thereby ensuring that the user complies with the postal address standardization program for their old address and their new address.

Whether or not the user is familiar with the postal address standardization program, the user is prompted to enter their old address and new address information in a standard format. This is significant since the Post Office requires addresses to be in one of the standard formats in order to ensure proper delivery of mail. It is impractical for the system provider to manually review each of the addresses input by the users of the system, as would occur in the U.S. Post Office upon receiving an address correction form by a postal customer, therefore the system prompts the user to provide the old address and the new address in a standard format the U.S. Post Office accepts.

FIG. 5B shows a list of address formats that are written in accordance with the postal address standardization program for Old and New Addresses to be entered by the user. FIG. 5C shows the web page returned to the user in which the input fields are specified according to the selected address format. In this example, the first listed format is selected for the old address and the second listed formal is selected for the new address. As shown in FIG. 5C, the input fields correspond with the selected formats. For example, note that the second listed format in FIG. 5B for the new mailing address enables the selection of an apartment of suite number including a drop down menu for the selection of either “apartment” or “suite”. Note also the use of the drop down menu for entry of the state as used in the address, in order to ensure compliance with postal regulations for the standardized abbreviations of states.

FIGS. 2-5 show the procedures for entering changes in a user's name, e-mail address and street address. Once this information has been input by the user, a personal folder page is returned to the user for prompting the user to generate a notification list of parties to whom notices will be sent of the change in information that has been input by the user.

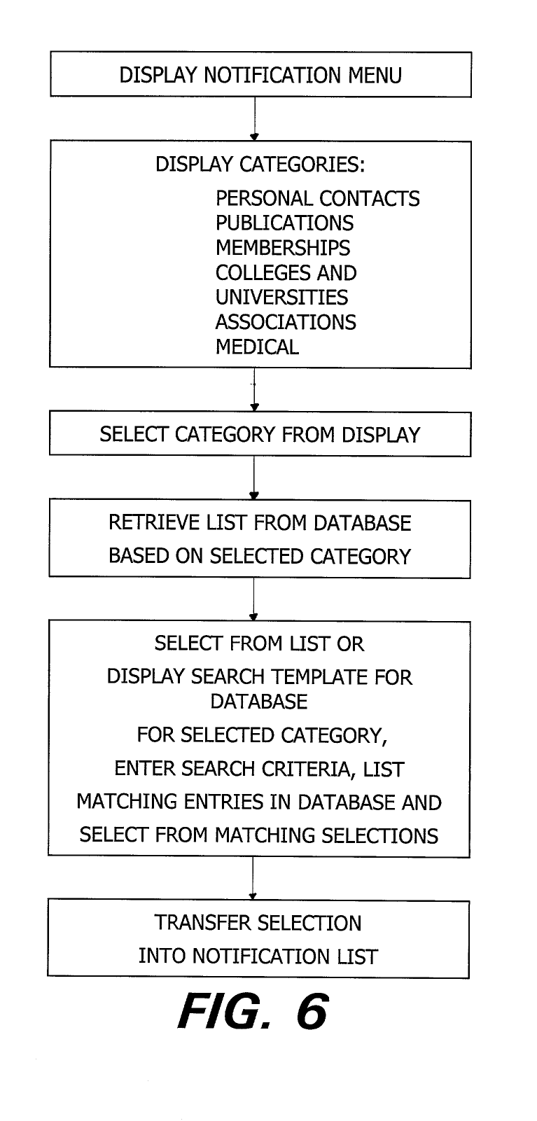

FIG. 6 shows the display notification menu procedure. The web page returned by the system server to the user includes a first page in which several categories of the type of parties to whom notices will be sent are displayed. For example, the categories include personal contacts, publications, memberships, colleges and universities, associations and medical. The user selects one category from the displayed list of categories and the system retrieves a list from a database based on the selected categories. Then, the user can select from the list or if a list is not displayed in response to selecting a category from the display, a search template for a data base is displayed and the user can enter search criteria for searching the database. In response, the system returns a page to the user listing the entries that match the search query and the user can select from the matching selections. Accordingly, the user can “drill down” on the specific party from a database of directories of publications, memberships, colleges and universities, a variety of associations and medical organizations and practitioners. The user makes each selection from a list returned to the user's computer. The selection is transferred to the user's personal folder and displayed in the notification list as shown in the last step of FIG. 6.

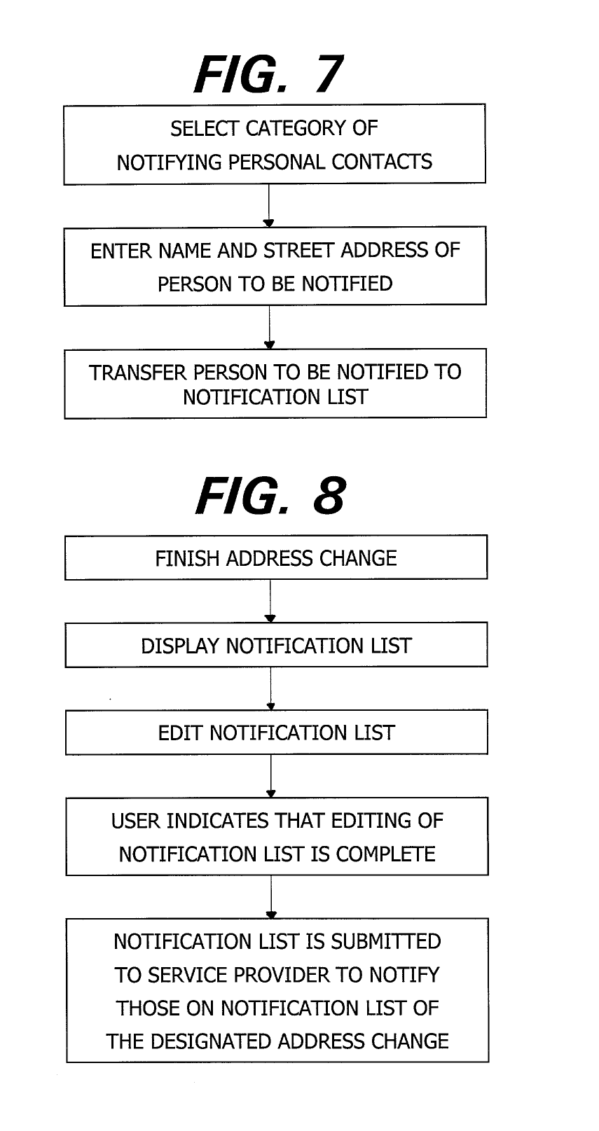

With respect to selecting the category of personal contacts, FIG. 7 shows the flow chart for this procedure. First, a user selects a category of notifying personal contacts and the system returns a page prompting the user to enter the name, street and/or e-mail address of the person to be notified. Then, after completing the information requested by the system, the information of the personal contact is transferred to the notification list.

FIGS. 6 and 7 explain the process for creating a notification list for the personal folder of the user of the system. After the notification list has been generated, the user proceeds to the next web page for finishing the address change. First, the system returns a web page displaying the notification list to the user. Then, the user is permitted an opportunity to edit the notification list. After editing of the notification list, the user indicates that the editing is complete, for example by double clicking on an icon displayed on the web page. Then, the notification list is submitted to the service provider through the web site and notifications are sent to the designated parties on the notification list so that each receives the designated address change, name change, or e-mail address change.

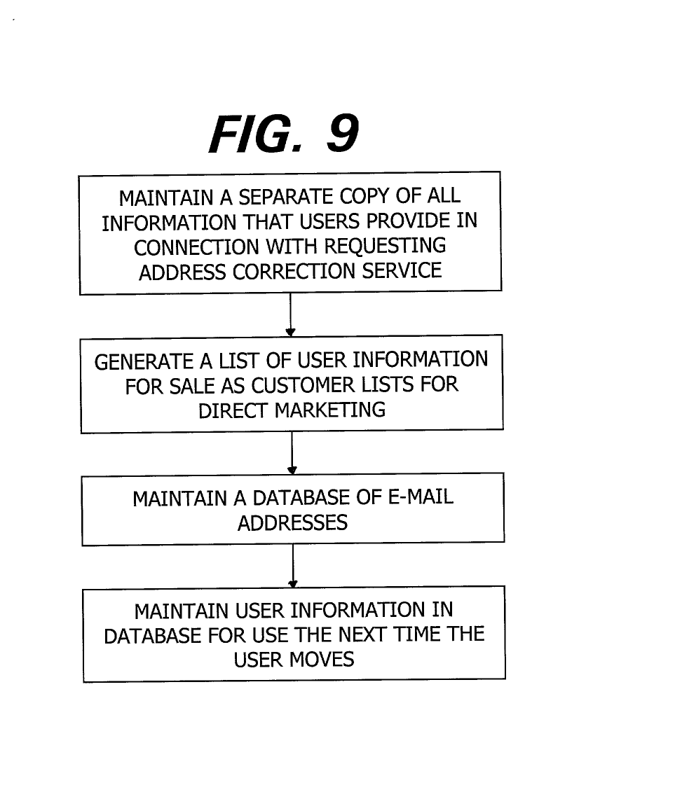

Through the use of the system, users are provided a convenient centralized way of sending notifications of changes in a user's name, e-mail address and street address. As shown in FIG. 9, a separate copy of all the information that users provide is maintained in a database by the server. From this information, the provider can generate list of user information that can be used as a customer list for direct marketing purposes, for example. Further, a database of email addresses and a history of changes in e-mail addresses can be maintained in a database by the service provider, which is useful for users logging on to the system who need to search for the current e-mail address of a party based upon an old e-mail address that a user might already know. Finally, the information maintained in the database of the service provider is organized according to the personal folders so that the next time the user's name changes, or a change in the user's e-mail address or street address occurs, the notification list of the user's personal folder can be used to send the appropriate notifications along with an opportunity to update and edit the notification list beforehand.

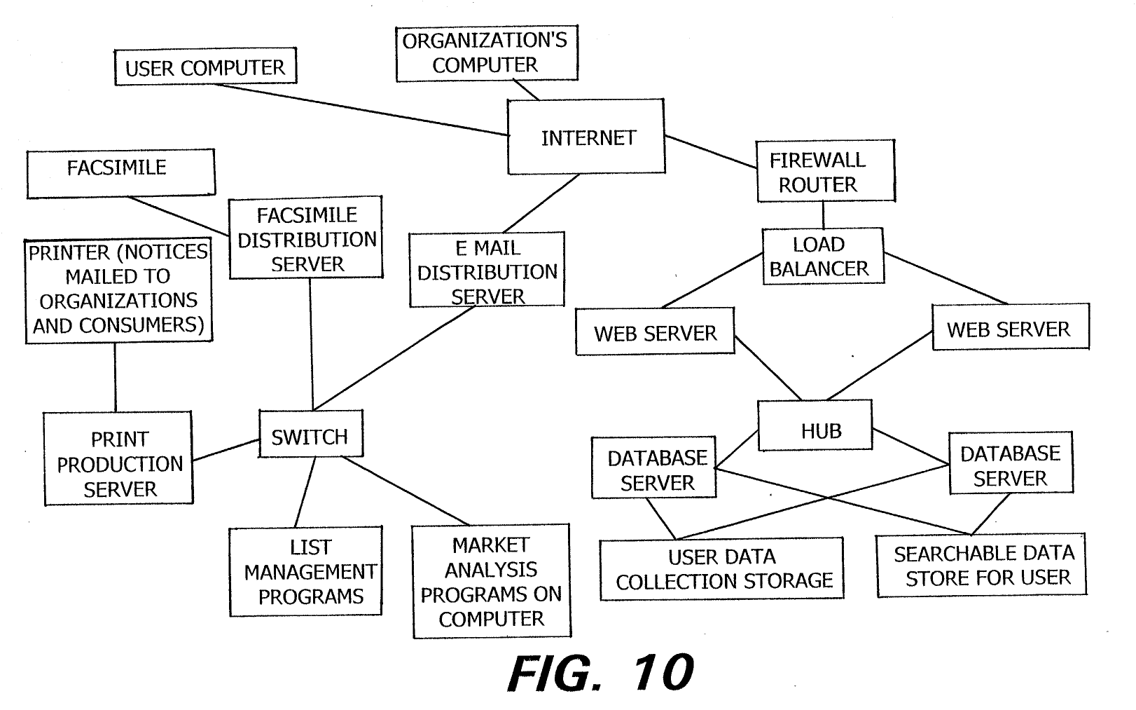

FIG. 10 shows an infrastructure diagram of the hardware required to implement the system of the present invention according to a preferred embodiment. In particular, the service is centered around the use of the internet. Connected to the internet are the user's computer and the organization's computer, for example organizations that provide directory information and that are to receive notifications of the changes in the user's information. The system is connected to the internet through a firewall router. To handle the hits to the web site, two web servers are contemplated that are connected to the internet through a load balancer and the firewall router. The web servers send and receive information through hub connected to database servers that are connected to the user data collection storage and the searchable data storage for the user.

As also shown in FIG. 10, an e-mail distribution server is connected to the internet and through a standard switch, the notices requested by a user are sent to a facsimile distribution server or a print production server for subsequent transmittal through a facsimile machine or to a printer where notices are printed and then mailed to the organizations and consumers identified by the user. Also, the switch enables transfer of data to the list management programs and the market analysis programs on the computer.

Since the service provider receives user profile information and change of address information, the service provider can maintain an up to date list of users who can be classified according to the profile information for targeting through direct marketing. The targeting of the offers can include advertising of services to the users which will be most useful to them based on the profile information. Further, information of the user's profile can be supplemented through the information obtained from the notification list created by the user. For example, the user may select publications concerning sports. Then, the targeted offers would be focused on offering services and advertisements that are of interest to persons involved in sports.

The system offers a user the advantage of ensuring reliable address change, name change and e-mail change notifications to a wide range of parties to whom the user desires to notify. Often times, it is difficult for a user to determine who should receive the notices of change of address, for example, when a user is moving. The system prompts the user to consider a wide variety of parties to contact through the web pages returned to the user at the web site. Also, the system provides access to searchable databases so that the user can inform the proper party using the correct notification form and address correction request form of the party to whom the notice should be sent, without actually having to procure such forms. This greatly simplifies the process of changing one's name, e-mail address or street address.

The provider of the system who maintains the web site provides a valuable service to the users who contact the web site, but also receives information that is useful for building a database of users having a variety of profile information, not the least of which is the user's current and up to date name, e-mail address and street address. Further, however, the user's profile can include information that is entered by the user through prompting at the web site and by information that is deduced from the notification list created by the user in building the user's personal folder. Accordingly, the system and method of the present invention are useful for both consumers and web site providers of the service.

While a preferred embodiment of the invention has been set forth with specific details, further embodiments, modifications and variations are contemplated according to the broader aspects of the present invention, all as determined by the spirit and scope of the following claims.

I claim:

1. A system of developing a personal folder via the internet of parties to whom notifications are to be sent of changes in at least one of name, address and e-mail information, comprising:
a web server and database connected to said web server, said web server receiving information over the internet from computers of users who register changes in name, address and/or e-mail information stored in the database;
a firewall server connected between said web server and said users' computers;
said web server hosting a plurality of web pages for prompting users of a procedure for changing a user's name, address and/or e-mail information at said users' computers;
means for generating a personal folder for each user in said database and for adding parties to be notified of said address change information, said means including said web server displaying a template on a user's computer for use by a user in searching for records retrieved from directories and displaying the records;
mans for selecting the displayed records as a party to be notified of the changed information input by a user and transferring said selected records to said personal folder for generating a notification list of parties to be notified of said change in a user's name, address and/or e-mail information; and
means for sending the notice of a change in a user's name, address and/or e-mail information to the parties in said notification list.

2. A system according to claim 1, wherein said web pages include a first page for prompting a user to select one of a plurality of formats that matches a user's old and new addresses, respectively, and a second web page that corresponds to the selected formats that displays fields in which change information is entered according to said selected formats to ensure compliance in entry of change information for the selected format.

3. A system according to claim 1, further including a database of user profile information based on information entered by a user in the procedure for changing a user's name, address and/or e-mail information, including information of a user's notification list.
